(19) United States
(12) Patent Application Publication
(10) Pub. No.: US 2024/0094415 A1
(43) Pub. Date: Mar. 21, 2024

(54) SYSTEM AND METHOD FOR DETECTING OUTLIERS IN GNSS OBSERVATIONS

(71) Applicant: Swift Navigation, Inc., San Francisco, CA (US)

(72) Inventors: Joseph Angelo, San Francisco, CA (US); Christian Reimer, San Francisco, CA (US); Sébastien Carcanague, San Francisco, CA (US)

(73) Assignee: Swift Navigation, Inc., San Francisco, CA (US)

(21) Appl. No.: 18/513,782

(22) Filed: Nov. 20, 2023

Related U.S. Application Data
(63) Continuation of application No. 18/116,117, filed on Mar. 1, 2023, now Pat. No. 11,860,287.
(60) Provisional application No. 63/315,426, filed on Mar. 1, 2022.

(51) Int. Cl. G01S 19/45; G01S 19/20; G01S 19/39; G01S 19/43; G01S 19/49

(52) U.S. Cl. CPC G01S 19/45; G01S 19/20; G01S 19/393; G01S 19/43; G01S 19/49

(57) ABSTRACT

An system and/or method for detecting outliers in satellite observations can include: receiving satellite observations associated with one or more satellite constellations; receiving sensor data; determining a GNSS positioning solution using a filter to process the satellite observations; determining a fused positioning solution; detecting whether outliers are present in the satellite observations; and when outliers are detected, updating the GNSS positioning solution and/or the fused positioning solution using a set of outlier mitigated satellite observations.

### CROSS-REFERENCE TO RELATED APPLICATIONS

This application is a continuation of U.S. application Ser. No. 18/116,117 filed 1 Mar. 2023, which claims the benefit of claims the benefit of U.S. Provisional Application No. 63/315,426, filed 1 Mar. 2022, which is incorporated in its entirety by this reference.

### TECHNICAL FIELD

This invention relates generally to the satellite positioning field, and more specifically to a new and useful system and method in the satellite positioning field.

### BRIEF DESCRIPTION OF THE FIGURES

FIG. 1 is a schematic representation of the system.

FIG. 2 is a schematic representation of the method.

FIG. 3 is a schematic representation of an example of data flow between a GNSS filter and a fusion filter.

FIG. 4 is a schematic representation of an example of detecting outliers using a duplicated filter.

FIG. 5 is a schematic representation of an example of a fusion engine.

FIGS. 6A and 6B are schematic representations of examples of variants of the method.

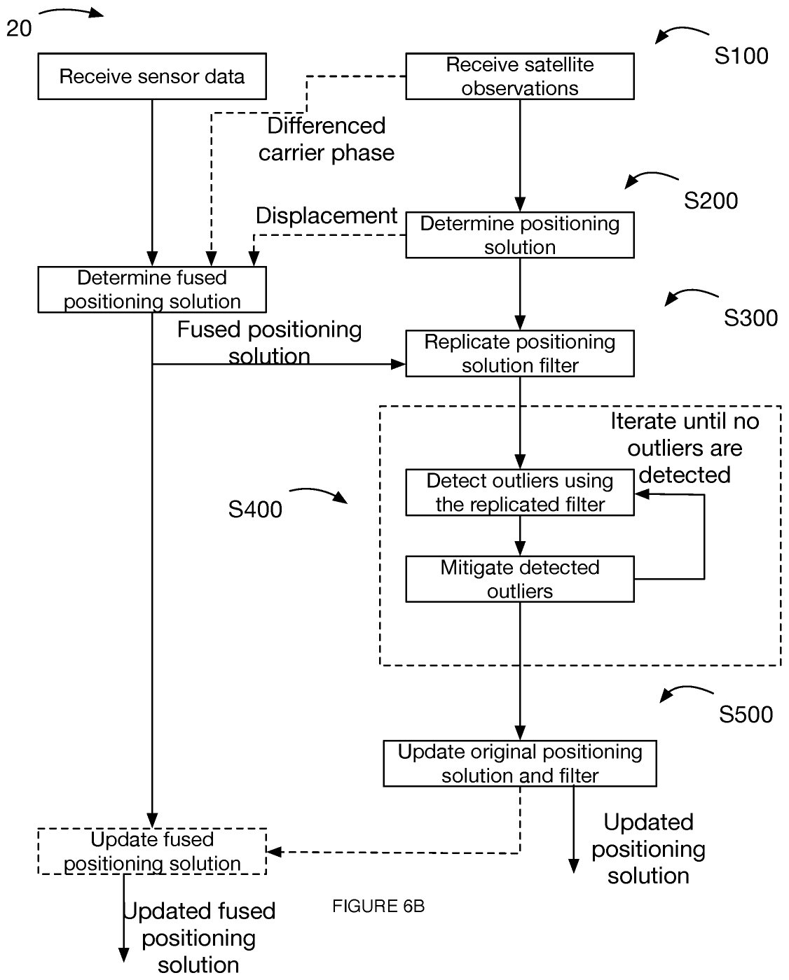

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview.

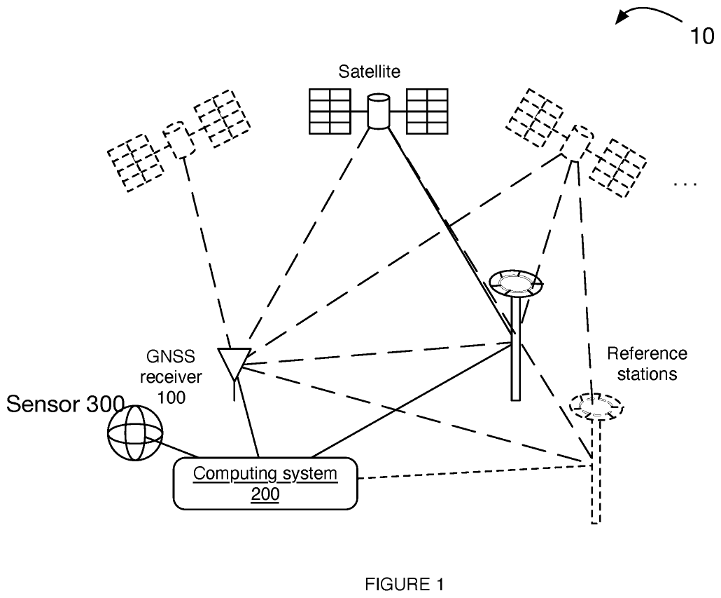

As shown in FIG. 1, the system 10 can include one or more data sources (e.g., satellites, reference stations, etc.), one or more computing systems 200, one or more GNSS receivers 100, one or more sensors 300, and/or any suitable components.

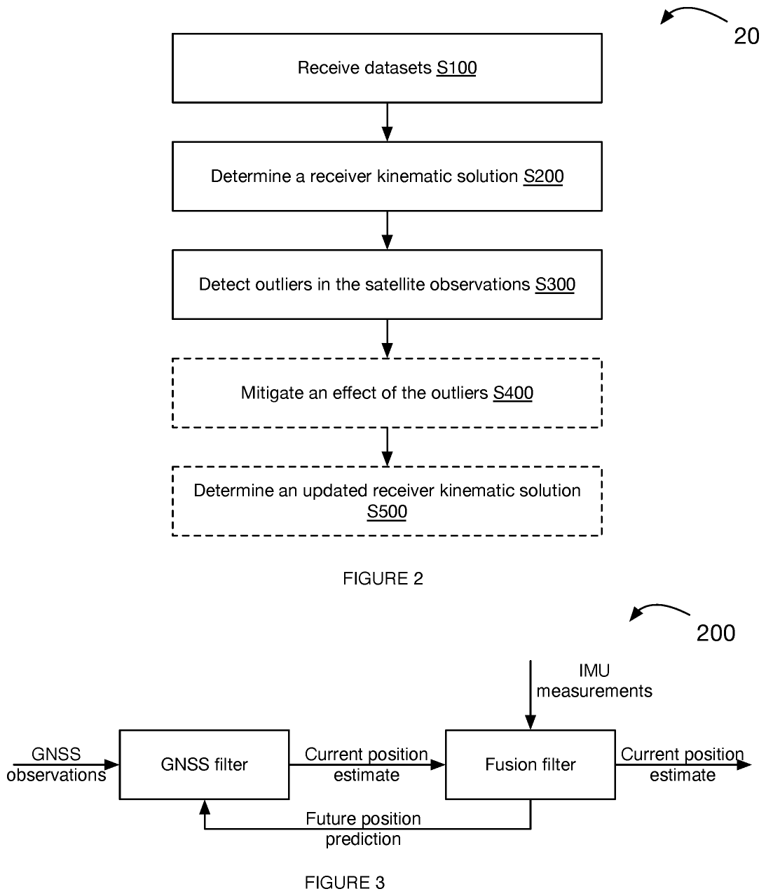

As shown in FIG. 2, the method 20 can include receiving datasets S100, determining a receiver kinematic solution S200, detecting outliers S300, mitigating an effect of the outliers S400, determining an updated receiver position S500, and/or any suitable steps.

The system and method preferably function to detect (e.g., determine, identify, measure, etc.) outlier(s) in GNSS observations to enable determination of a receiver kinematic solution with a high accuracy (e.g., cm-level, dm-level, m-level, etc.), availability, integrity, and/or other property. However, the GNSS observations can be otherwise used.

Embodiments of the system and/or method can be used, for example, in autonomous or semi-autonomous vehicle guidance (e.g., for unmanned aerial vehicles (UAVs), unmanned aerial systems (UAS), self-driving cars, agricultural equipment, robotics, rail transport/transit systems, autonomous trucking, last mile delivery, etc.), GPS/GNSS research, surveying systems, user devices, mobile applications, internet-of-things (IOT) devices, and/or may be used in any other suitable application. In specific examples, the system (and/or components) can be coupled to any suitable external system such as a vehicle (e.g., UAV, UAS, car, truck, etc.), robot, railcar, user device (e.g., cell phone), and/or any suitable system, and can provide positioning data, integrity data (e.g., protection level data), and/or other data to said system, wherein the system can use the data for control and/or navigation.

### 2. Benefits.

Variations of the technology can confer several benefits and/or advantages.

First, variants of the technology can enable improved outlier detection in GNSS measurements. In specific examples, the technology can enable improved outlier detection using sensor fusion positioning estimates in a filter without a fully tightly coupled solution (e.g., without a circular feedback loop).

Second variants of the technology can improve and/or assist with carrier phase ambiguity resolution. In a specific example, by using a duplicate filter the outlier detection is less likely to disturb an ambiguity state (e.g., carrier phase ambiguity) as compared to performing the outlier detection within the primary filter. Because the ambiguity state is less likely to be disturbed, better performance (e.g., greater availability, greater accuracy, etc. from anticipated lower quality satellites, from fewer satellites, etc.) can be realized. Additionally, or alternatively, ambiguity fixes that may not have been possible can be achieved.

Third, variants of the technology can enable looser thresholds on a number of satellites and/or fraction of satellite observations observed to be outliers for updating a sensor fusion filter. For instance, rather than using satellite observations associated with at least 4 (and typically at least 5 or 6 to include redundancy) distinct satellites to update a sensor fusion filter, examples of the technology can enable the sensor fusion filter to be updated with <4 distinct satellites (e.g., 1, 2, 3 satellites). In another example, an outlier fraction threshold (e.g., a threshold for what percentage of the satellite signals can be identified as potential, probable, definite, etc. outliers before the positioning engine and/or sensor fusion engine does not perform an update using the satellite signals) can be increased. For instance, an outlier fraction threshold can be 25%, 33%, 40%, 50%, 60%, 75%, 80%, 90%, 95%, and/or any suitable percentage. This technical advantage can be achieved as variants of the technology can be more accurate at detecting outliers and/or inliers.

However, variants of the technology can confer any other suitable benefits and/or advantages.

### 3. System.

As shown in FIG. 1, the system can include one or more data sources, one or more computing systems, one or more sensors (e.g., IMU sensor, DMI sensor, wheel tick, etc.), and/or one or more GNSS receivers. The system can function to determine kinematic properties of a receiver (e.g., position, velocity, acceleration, jerk, jounce, snap, crackle, pop, higher derivatives of position with respect to time, attitude, elevation, altitude, etc.), detect outliers in GNSS observations, and/or can otherwise function.

The system preferably uses a set of data collected by one or more data sources. Data sources can include: receivers, sensors (e.g., located onboard the receiver, the external system, the reference stations, etc.), databases, satellites, reference stations, and/or any other suitable data source. Examples of data that can be used include: GNSS observations, sensor observations, and/or any other suitable data.

The receiver 100 preferably functions to receive a set of GNSS observations (e.g., satellite signals such as carrier phase and satellite code) from one or more satellites. In variants, the receiver can determine the location of the receiver (and/or external system) based on the GNSS observations. The receiver is preferably in communication with the computing system. However, the receiver can be integrated with the computing system, and/or the receiver and computing system can be arranged in any suitable manner. The receiver is preferably a stand-alone device (e.g., a GNSS receiver, antenna). However, the receiver can be integrated into an external system (e.g., be a component of an automobile, aero vehicle, nautical vehicle, mobile device, etc.), can be a user device (e.g., smart phone, laptop, cell phone, smart watch, etc.), and/or can be configured in any suitable manner.

The set of GNSS observations can include orbital data (e.g., ephemeris), timestamp, range rate data, carrier phase data, pseudorange data, and/or any suitable data. The set of GNSS observations can include and/or be associated with metadata (e.g., ephemeris data) and/or any suitable data or information. The set of GNSS observations preferably includes GNSS observations corresponding to satellites from a plurality of satellite constellations (e.g., Global Positioning System (GPS), GLObal Navigation Satellite System (GLONASS), BeiDou navigation satellite System (BDS), Galileo, Quasi-Zenith Satellite System (QZSS), etc.). However, the set of GNSS observations can correspond to satellites from a single satellite constellation, can include data from an augmentation system (e.g., Satellite Based Augmentation System (SBAS) such as Wide Area Augmentation System (WAAS), European Geostationary Navigation Overlay Service (EGNOS), Multi-Functional Satellite Augmentation System (MSAS), GPS Aided Geo Augmented Navigation (GAGAN), Omnistar, StarFire, etc.; Ground Based Augmentation Systems (GBAS) such as Local Area Augmentation System (LAAS); etc.), and/or can include any suitable data.

In variants of the system including more than one receiver, each receiver can be configured to receive GNSS observations corresponding to a satellite constellation, to a carrier frequency (e.g., the L1, L2, L5, E1, E5a, E5b, E5ab, E6, G1, G2, G3, B1, B2, B2a, B2b, B2ab, B3, LEX, etc. frequencies), and/or corresponding to any suitable source.

The reference station(s) preferably function to receive a set of GNSS observations (e.g., reference station GNSS observations) and transmit the reference station GNSS observations to the computing system (and/or to the receiver). The GNSS observations from the reference station(s) can be used to determine corrections (e.g., local and/or global corrections such as to account for atmospheric effects such as ionosphere delay, troposphere delay, ionosphere gradient, etc.; orbit errors; clock errors; hardware biases; antenna offsets such as phase center offset, phase center variation, etc.; ocean tides; pole tides; solid Earth tides; etc.) to the set of GNSS observations measured (or otherwise received) by the receiver.

The sensor(s) 300 preferably function to measure sensor data associated with the external system and/or the GNSS receiver. The sensor data is preferably used to determine (e.g., independent of the GNSS observations) the external system (or the sensor) kinematic parameters, but can additionally or alternatively be used to assist (e.g., speed-up, correct, refine, etc.) the calculation (e.g., calculating the state vector, estimating the phase ambiguity) of kinematic parameters from the GNSS observations and/or be otherwise used. The sensors are preferably in communication with the computing system, but can be integrated into the computing system, connected to the computing system, be separate from the computing system (e.g., connect to the computing system through an intermediary system), and/or can otherwise be arranged.

The sensor(s) can be: on-board the external system, on-board a separate external system, integrated into the GNSS receiver, separate from the GNSS receiver, and/or otherwise associated with the GNSS receiver.

The sensor data can include: inertial data (e.g., velocity, acceleration, angular velocity, angular acceleration, magnetic field, etc.), odometry, distance, pose (e.g., position, orientation, etc.), mapping data (e.g., images, point clouds), temperature, pressure, ambient light, landmarks (e.g., image key features), images, video feeds, and/or any other suitable data. The sensors can include one or more of: inertial measurement unit (IMU), accelerometer, gyroscope, magnetometer, odometer (e.g., wheel speeds; wheel ticks; steering angles; visual odometers such as cameras; etc.), distance measurement instrument (DMI), image sensor (e.g., camera, stereo camera, depth camera, etc.), pressure sensors, and/or any suitable sensor.

The computing system 200 preferably functions to process the data (e.g., GNSS observations) from the receiver and/or the reference stations. The computing system can: aggregate the data (e.g., combine the receiver GNSS observations, reference station GNSS observations, and sensor data; reorganize the receiver GNSS observations, reference station GNSS observations, and sensor data such as based on the time stamp, time of transmission, time of receipt; etc.), filter the data (e.g., to calculate state vectors, ambiguities such as phase ambiguities, etc. associated with the data), calculate the receiver position (e.g., based on ambiguities), correct the data (e.g., correct the GNSS observations for orbit errors, clock errors, hardware biases, antenna offsets, atmospheric effects, ocean tides, pole tides, etc.), detect outliers (e.g., cycle slips, etc.), and/or can process the data in any suitable manner. The computing system can be local (e.g., on-board the external system, integrated in a receiver, integrated with a reference station, etc.), remote (e.g., cloud computing, server, networked, etc.), and/or distributed (e.g., between a remote and local computing system).

The computing system is preferably communicably coupled to the receiver, to the reference station, but the computing system can be in communication with any suitable components. In variants, the computing system can include one or more: communication module, filter, outlier detection module, and/or any suitable modules.

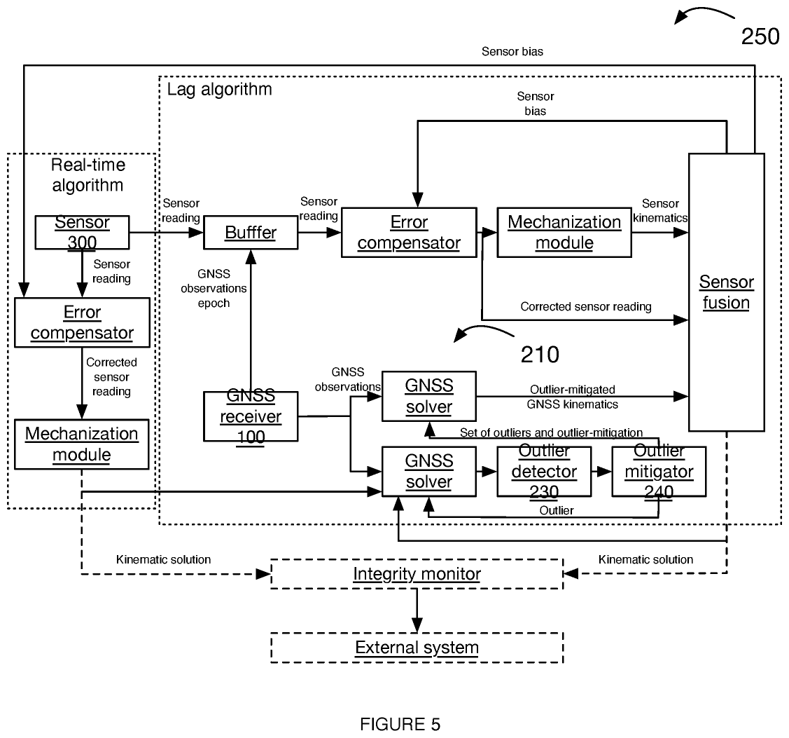

As shown for example in FIG. 4, the computing system can include a positioning engine (e.g., including a filter such as a Kalman filter, extended Kalman filter, unscented Kalman filter, etc. configured to estimate a rover or receiver positioning solution based on the satellite observations), a fusion engine (e.g., a sensor fusion engine that can include a filter such as a Kalman filter, extended Kalman filter, unscented Kalman filter, etc. configured to estimate a rover or receiver fused positioning solution and/or sensor errors such as sensor bias using sensor measurements and a positioning solution from the positioning engine, using processed satellite observations such as disclosed in U.S. patent application Ser. No. 18/115,963 titled ‘SYSTEM AND METHOD FOR FUSING SENSOR AND SATELLITE MEASUREMENTS FOR POSITIONING DETERMINATION’ filed 1 Mar. 2023 which is incorporated in its entirety by this reference, etc.), a duplication module (e.g., configured to duplicate a filter of the positioning engine and/or fusion engine which can provide a technical advantage of decreasing a risk of data contamination and/or inability to fully roll back a filter update resulting from outlier detection), an outlier detector (e.g., configured to detect one or more outliers in the set of satellite observations, satellite signals, sensor data, sensor readings, sensor measurements, etc.), an outlier mitigator (e.g., configured to mitigate an impact of one or more outliers on the positioning solution and/or fused positioning solution), and/or any suitable modules and/or components. In some examples, the duplication module, the outlier detector, the outlier mitigator, and/or any suitable components can be integrated in the positioning engine and/or the fusion engine. However, the modules and/or engines can otherwise be integrated and/or isolated from one another. In a specific example, the computing system can include any suitable components as disclosed in U.S. patent application Ser. No. 18/073,304 titled “SYSTEM AND METHOD FOR FUSING SENSOR AND SATELLITE MEASUREMENTS FOR POSITIONING DETERMINATION” filed 1 Dec. 2022 which is incorporated in its entirety by this reference.

### 4. Method.

As shown in FIG. 2, the method 20 can include receiving dataset(s) S100, determining a receiver kinematic solution S200, detecting outliers S300, mitigating an effect of the outliers S400, determining an updated receiver position S500, and/or any suitable steps.

The method preferably functions to determine (e.g., detect, measure, identify, analyze, etc.) outliers in a set of GNSS observations, where the GNSS observations (e.g., inliers of the GNSS observations) can be used to estimate (e.g., calculate, determine) a receiver position (e.g., as part of a positioning engine, fusion engine, etc.). Steps and/or substeps of the method can be performed iteratively (e.g., for different epochs, for the same epoch, etc.), sequentially (e.g., for different external systems), and/or in any suitable order. The steps and/or substeps of the method can be performed in series and/or in parallel. The steps and/or substeps are preferably performed by a system as described above, but can be performed by any system.

Receiving datasets S100 functions to measure, acquire, receive, access, etc. one or more sets of data that can be used to determine a receiver positioning solution. Exemplary datasets can include: GNSS observations (e.g., from a shared epoch; from one or more epochs such as sequential epochs, epochs spaced by a predetermined amount of time, etc.; etc.), sensor data (e.g., sensor readings, sensor measurements, etc.), external system data (e.g., steering wheel, map data, etc.), and/or any suitable data. Receiving the datasets can include transmitting the datasets to a computing system and/or to a receiver (e.g., from a database), monitoring the datasets (e.g., for a predetermined event, for faults, etc.), and/or any suitable steps. The datasets can be stored (e.g., temporarily stored such as in short-term memory, cache, etc.). When more than one dataset is received (e.g., GNSS observations and sensor data), the datasets are preferably received (e.g., acquired) contemporaneously (e.g., concurrently, simultaneously, etc.), but can be received in any order.

Receiving datasets can include receiving the GNSS observations S100 functions to measure and/or detect a set of satellite signals, where each satellite signal is associated with a satellite, at a reference station, a receiver, and/or at any suitable endpoint. The satellite signals can include satellite code, satellite pseudorange, carrier phase, and/or any suitable data. The GNSS observations are preferably received (e.g., acquired) at a GNSS acquisition frequency. The GNSS observations are preferably associated with a timestamp. The timestamp is preferably the time the GNSS observations were acquired but can be the time of receipt (e.g., by the computing system), the time of processing, and/or be any suitable time.

Receiving datasets can include receiving sensor data, which functions to receive data from one or more sensors. The sensor data is preferably received by a computing system, but can be received by any suitable component. The sensor data can be received from a sensor, a computing system (e.g., database, etc.), and/or from any suitable system. The sensor data is preferably received (e.g., acquired) at a sensor acquisition frequency. The sensor acquisition frequency can be less than, the same as, and/or greater than the GNSS observation frequency. The sensor data is preferably associated with a timestamp. The timestamp is preferably the time the data was acquired but can be the time of receipt (e.g., by the computing system), the time of processing, and/or be any suitable time. In a first illustrative example, receiving sensor data can include receiving acceleration and/or rotation data from an accelerometer and/or gyroscope. In a second illustrative example, receiving sensor data can include acquiring one or more images, where the images can be processed (e.g., using artificial intelligence, manually, using image processing algorithms, using stereoimage algorithms, monocular vision algorithms, etc.). In a third illustrative example, receiving sensor data can include measuring or receiving wheel tick (or other odometry or distance measuring instrument) and/or steering angle data. In a fourth illustrative example, any or all of the preceding three examples can be combined. However, any suitable sensor data can be received.

In some variants, receiving the sensor data can include processing the sensor data. For example, the sensor data can be (pre)processed to remove, account for, mitigate, and/or otherwise correct for sensor error terms (e.g., sensor bias, sensor thermal bias, scale factors, nonlinearities, nonorthogonalities, misalignments, g-sensitivity, g²-sensitivity, cross-axis sensitivity, etc.). However, the sensor data can be processed within a filter (e.g., an error estimator of a fusion engine, in S200, etc.) and/or can otherwise be processed.

Receiving the datasets can include synchronizing the datasets, which can function to align datasets to a common time basis. For example, sensor data can be synchronized to (e.g., time aligned) to the GNSS observations, GNSS observations can be synchronized to the sensor data, GNSS observations and sensor data can be aligned to an external reference, a common reference can be used, and/or the datasets can otherwise be synchronized.

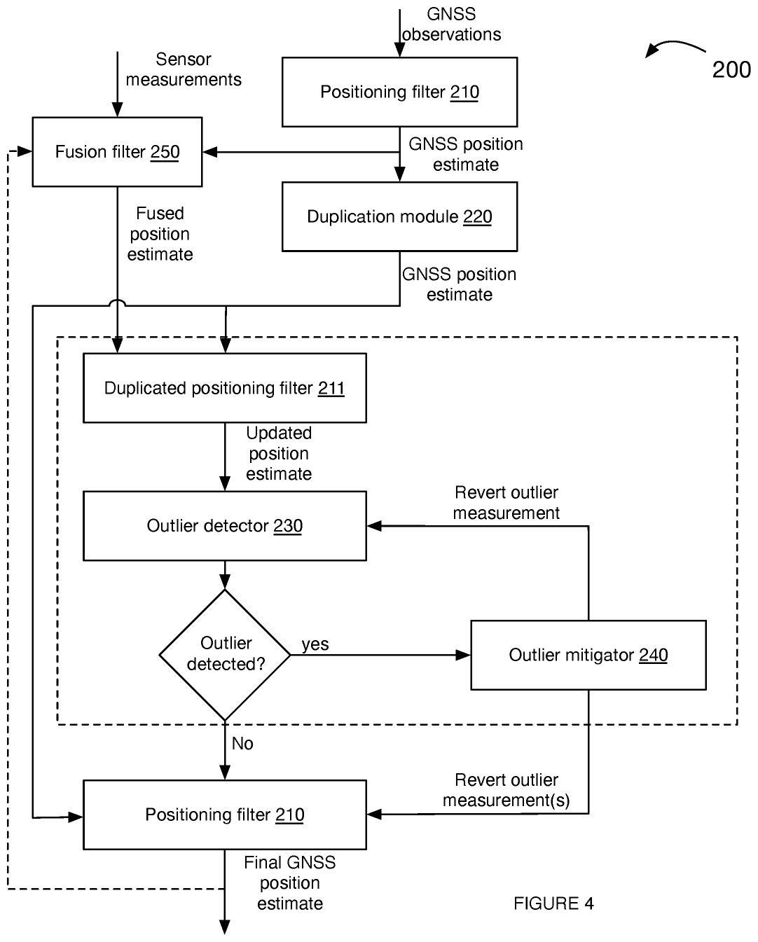

Determining the receiver positioning solution S200 functions to determine the GNSS receiver and/or rover position to high accuracy (e.g., receiver position is known to within 1 mm, 2 mm, 5 mm, 1 cm, 2 cm, 5 cm, 1 dm, 2 dm, 5 dm, 1 m, 2 m, 5 m, 10 m, values or ranges therebetween, etc.). The receiver positioning solution is preferably determined by the receiver (e.g., a computing system thereof, a positioning engine, a fusion engine, etc.), but can be determined by the computing system and/or any component. The receiver position solution can be determined using sensor data (e.g., using a fusion engine), GNSS observations (e.g., using a positioning engine), and/or any suitable data can be used (e.g., landmarks). The sensor data and the GNSS observations are preferably loosely coupled (e.g., a fusion filter ingests a position estimate determined based on the GNSS observations rather than the GNSS observations directly, as shown for example in FIG. 3, etc.), but can be tightly coupled (e.g., a fusion filter can ingest raw GNSS observations and raw sensor data), semi-tightly coupled (e.g., a fusion filter can ingest processed GNSS observations and raw or processed sensor data), and/or otherwise be coupled when both data types are used to determine the receiver positioning solution.

The receiver positioning solution can be determined using an estimator and/or any suitable method and/or algorithm. Exemplary estimators include: Kalman filters (e.g., unscented Kalman filters, extended Kalman filters, recursive Kalman filters, etc.), particle filters (e.g., monte carlo simulators), least squares solution calculators (e.g., running an iterative snapshot least squares method), a Gaussian process, and/or any suitable estimator can be used.

Determining positioning solution using GNSS observations functions to determine the GNSS positioning solution of the external system, sensor, and/or GNSS receiver based on the GNSS observations. Determining the GNSS positioning solution is preferably performed as GNSS observations are received, but can be performed as the sensor data is received and/or with any suitable timing. The GNSS positioning solution can be determined in a manner analogous to the determination of position, velocity, acceleration, higher order derivatives of position with respect to time (e.g., jerk, jounce, snap, crackle, pop, etc.), attitude, and/or other suitable positioning solution terms as disclosed in U.S. patent application Ser. No. 16/685,927 filed 15 Nov. 2019 entitled “SYSTEM AND METHOD FOR SATELLITE POSITIONING,” U.S. patent application Ser. No. 16/817,196 filed 12 Mar. 2020 entitled “SYSTEMS AND METHODS FOR REAL TIME KINEMATIC SATELLITE POSITIONING,” and/or U.S. patent application Ser. No. 17/022,924 filed 16 Sep. 2020 entitled ‘SYSTEMS AND METHODS FOR HIGH-INTEGRITY SATELLITE POSITIONING,’ each of which is incorporated in its entirety by this reference. However, the GNSS positioning solution can be determined from the GNSS observations in any manner. When GNSS observations associated with a plurality of GNSS receivers (e.g., antennas) are measured, determining the GNSS positioning solution can be performed independently for GNSS observations from different GNSS receivers and/or determining the GNSS positioning solution can be performed in a manner that merges the GNSS observations for different GNSS receivers.

Determining the receiver positioning solution using GNSS observations can include: determining a carrier phase ambiguity (e.g., a float carrier phase ambiguity, an integer carrier phase ambiguity, etc.), calculating the receiver positioning solution based on the carrier phase ambiguity, determining a baseline vector between a receiver and a reference station, determining an absolute receiver positioning solution (e.g., by applying the baseline vector to the reference station location), determining a relative receiver positioning solution (e.g., relative to a prior time point, epoch, etc.), and/or any steps. Determining the receiver positioning solution using GNSS observations can use a GNSS estimator (e.g., an estimator that can ingest GNSS observations), a fusion estimator (e.g., an estimator that can ingest GNSS observations, sensor data, etc.), and/or any suitable estimator.

Determining a positioning solution using sensor data functions to determine the positioning solution of the external system, sensor, and/or GNSS receiver based on the sensor data. Determining a sensor positioning solution (e.g., fused positioning solution) is preferably performed as sensor data is received, but can be performed at a delayed time (e.g., as GNSS observations are received), and/or with any suitable timing. The fused positioning solution is preferably determined using a fusion estimator (e.g., Kalman filter, extended Kalman filter, unscented Kalman filter, Gaussian process, etc. that ingests sensor readings, GNSS positioning solution, processed satellite observations, raw satellite observations, corrections information, reference station observations, etc. to determine the fused positioning solution, sensor error(s), positioning solution covariances, etc.). Determining a fused positioning solution preferably includes determining the positioning solution using a mechanization model and integrating the mechanized data. The mechanization model and/or integrator can account for earth rotation, Coriolis forces, gravity, and/or any other real or fictitious forces to calculate or update the fused positioning solution from a previously computed positioning solution. However, the positioning solution can be otherwise determined from the sensor data. When sensor data associated with a plurality of sensors is measured, determining a positioning solution can be performed independently for sensor data from different sensors, sensor data for different sensors can be merged and/determined in a unified manner (e.g., accounting for, leveraging, etc. a lever arm effect between sensors), and/or the kinematic parameters can otherwise be determined. The mechanization model preferably uses (e.g., leverages) small angle approximations, which can provide a technical advantage of simplifying the mechanization model (e.g., which can decrease a computational burden of the mechanization model). However, the mechanization model and/or integrator can otherwise function.

In some variants, the datasets can be measured at different measurement frequencies. In these variants, S200 can include separate lagging and real-time processes. For example, a GNSS positioning solution (and/or sensor error such as sensor bias) can be determined in a lagging process and a sensor fused position (e.g., position update using incoming sensor measurements) can be determined in a real-time process (with potential updates as new GNSS positioning solutions and/or sensor errors become available). However, S200 can be performed with any suitable timing.

S200 can include converting the positioning solution from a GNSS receiver and/or sensor reference frame to a body (e.g., rover) reference frame (e.g., based on a pose, transformation, etc. between the data source and the body reference frame).

In a specific example, the positioning solution (e.g., receiver positioning solution, rover positioning solution, GNSS positioning solution, fused positioning solution, kinematic solution, etc.) can be determined in a manner as disclosed in U.S. patent application Ser. No. 18/073,304 titled “SYSTEM AND METHOD FOR FUSING SENSOR AND SATELLITE MEASUREMENTS FOR POSITIONING DETERMINATION” filed 1 Dec. 2022 which is incorporated in its entirety by this reference (e.g., can include determining a motion state and modifying a filter based on the motion state, can include validating a positioning solution, fuse a GNSS positioning solution and sensor or fused positioning solution, etc.). However, the positioning solution can be determined in any manner.

Detecting outliers in the GNSS observations S300 functions to identify one or more GNSS observations as outliers. S300 is preferably performed by a receiver (e.g., a computing system of a receiver, an outlier detector, etc.), but can be performed by a computing system (e.g., a remote computing system), and/or by any suitable component. The outliers can be detected by an estimator (e.g., of a positioning engine, of a fusion engine, etc.), by an outlier detector, and/or by any suitable module.

Outliers can be detected sequentially, in parallel, and/or in any suitable order and/or timing. For example, a first outlier can be identified, the outlier can be mitigated (e.g., according to S400), and an estimator (e.g., a GNSS estimator, of a positioning engine, of a fusion engine, etc.) can produce an updated receiver positioning solution, where the updated receiver positioning solution can be used to check for a second (and so on) outlier. This process can be repeated (e.g., for a second, third, fourth, fifth, etc. outlier) until no outlier is detected. However, all outliers can be detected at the same time, and/or the outliers can be detected in any order and/or with any timing.

The outliers are preferably detected based on the receiver positioning solution (e.g., in state space, in a solution space, fused positioning solution compared to individual satellite positioning solution, etc.). However, additionally or alternatively, the outliers can be detected in an observation space (e.g., directly in the GNSS observations such as by converting the fused positioning solution to a predicted GNSS observation for each satellite in view of the receiver), based on a receiver positioning displacement (e.g., which can be beneficial in some situations as carrier phase ambiguities do not necessarily need to be determined when a receiver displacement is used but can leverage or use differences in carrier phase between different epochs such as consecutive epochs, nonconsecutive epochs such as separated in time by an amount of time depending on an application, an amount of), and/or in any suitable manner.

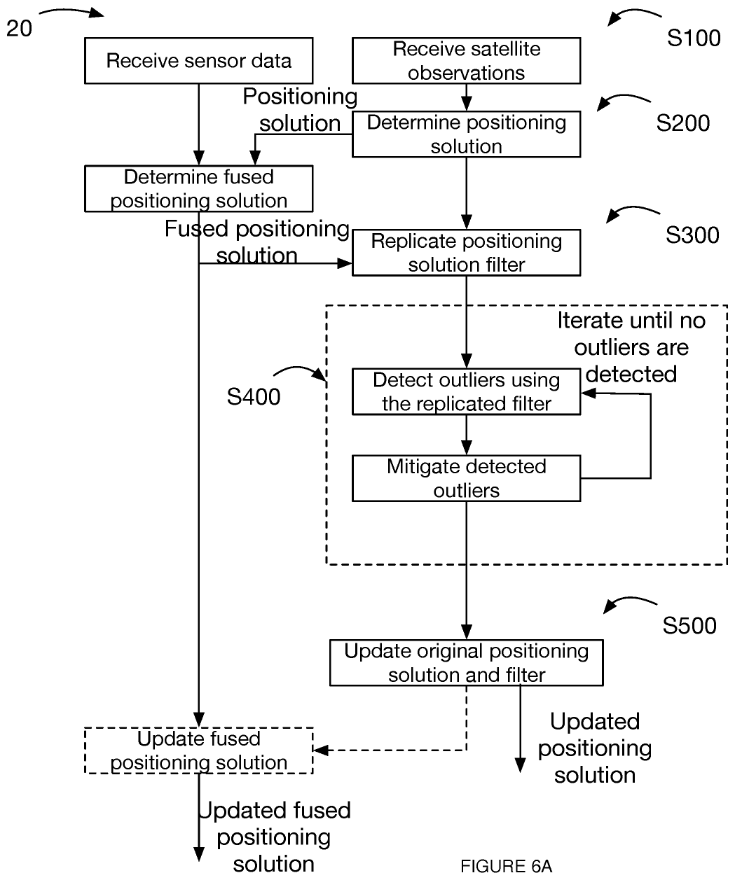

The outliers are preferably determined using (e.g., within, using a positioning solution calculated with, etc.) a second GNSS estimator (e.g., where the first, primary, etc. GNSS estimator is used to produce a GNSS receiver positioning solution that is transmitted to a fusion filter, used by an external system, etc.) and/or outlier detector associated therewith (as shown for example in FIG. 5). The use of the second GNSS estimator (e.g., a duplicate of the first or primary GNSS estimator) can provide a technical advantage of reducing data contamination from reversing an estimator update as outlier(s) are detected. However, the outliers can be determined using the GNSS estimator (e.g., the primary GNSS estimator), a fusion estimator (e.g., a primary fusion estimator, a secondary fusion estimator, etc.), an independent outlier detector, and/or any suitable component. The second GNSS estimator can be a duplicate of the GNSS estimator, an independent GNSS estimator (e.g., operating with the same inputs, models, noise, etc.; configured to generate the same output given the same input as a primary GNSS estimator; etc.), and/or can be any suitable estimator. In an illustrative example, detecting an outlier can include duplicating (and/or replicating) a GNSS estimator (e.g., as used in S200). The GNSS estimator is preferably duplicated after the original estimator has completed an update (e.g., after S200 is complete such that the duplicate copy has the updated states). However, the GNSS estimator can additionally or alternatively be duplicated before and/or during the original estimator update.

The second GNSS estimator preferably receives (in addition to the inputs to the GNSS estimator or primary GNSS estimator as in S200) a fused positioning solution as determined using a fusion filter (e.g., a current receiver positioning solution, a predicted receiver positioning solution, etc.). However, the second GNSS estimator can additionally or alternatively receive sensor data, sensor error(s), and/or any suitable information or data. The fused positioning solution (e.g., fusion receiver positioning solution, fusion receiver position solution, etc.) is preferably used to constrain the second GNSS receiver positioning solution (e.g., the position, average velocity, instantaneous velocity, acceleration, higher order derivatives of position with respect to time, attitude, etc.). For instance, the fusion receiver positioning solution can be used by the second GNSS estimator to test whether a state (e.g., a positioning solution estimated from a single satellite, single satellite constellation, etc.), GNSS observation, positioning solution, and/or other information is (e.g., includes, is associated with, etc.) an outlier. However, the fused positioning solution can additionally or alternatively be used by the second GNSS estimator to determine the GNSS positioning solution and/or can otherwise be used. The fused positioning solution can be provided at the GNSS antenna (e.g., the fusion estimator can be augmented with the GNSS antenna position), at an external vehicle reference (e.g., where the second GNSS estimator can receive a vehicle reference position offset relative to the GNSS antenna), and/or the fusion receiver positioning solution can be provided relative to any suitable reference.

The second GNSS estimator (and optionally the first GNSS estimator) can treat phase ambiguity as a continuous variable, can attempt to constrain the phase ambiguity to an integer. For example, detecting one or more outliers can include (e.g., after calculating a second position estimate) calculating phase measurement residuals and comparing those residuals to integer multiples of full phase cycles (e.g., 2πn). If the residual is close (e.g., differs from an integer value by at most a threshold), this may be indicative of a cycle slip, rather than an erroneous observation.

In some variants, detecting an outlier can include identifying an outlier as a cycle slip. For example, when a phase measurement residual is close to (e.g., within a threshold value of) an integer multiple of a half or full phase cycle, an outlier can be identified as a cycle slip. In some variations, the use of displacements (e.g., as opposed to, in addition to, etc. absolute position) can provide a technical advantage for facilitating cycle slip detection. In another example, identifying outlier(s) as cycle slips can include verifying that the value of the cycle slip can be chosen reliably (e.g., by verifying that only a single integer cycle slip value is contained within a known window of variance around the value of the residual), and testing the cycle slip value against the residual (e.g., by verifying that the cycle slip value is within a window of variance of the residual value; where two windows of variance described here may be distinct). However, an outlier can be identified as a cycle slip in any manner.

In a first specific example, a GNSS estimator can detect GNSS outliers by: generating a set of posterior observation residual covariances from the set of posterior observation residual values; calculating a set of posterior observation residual variances from the set of posterior observation residual covariances; scaling the set of posterior observation residual values using the set of posterior observation residual variances; and identifying at least one GNSS observation as a statistical outlier based on a corresponding scaled posterior observation residual value being outside a threshold range.

In a variation of the first specific example (sometimes referred to as a scaled residual technique), detecting one or more outliers can include calculating posterior residual values for the satellite data observations. That is, for observations zₖ and posterior state estimate \hat{x}_{k|k} (e.g., calculated in S200, fused positioning solution, GNSS positioning solution, etc.), detecting one or more outliers can include calculating the residual \tilde{v}_{k|k}=zₖ−Hₖ\hat{x}_{k|k} where Hₖ is an observation model that maps the true state space into the observed space and where \tilde{v}_{k|k} is sometimes additionally or alternatively referred to as the measurement post-fit residual or posterior observation residual. From the posterior observation residual, detecting one or more outliers can include determining (e.g., calculating, estimating, etc.) the posterior observation residual covariance, Cₖ=Rₖ−HₖP_{k|k}Hₖ^{T} where Rₖ is the covariance of nₖ and P_{k|k} is the updated state covariance.

In this variation, the variance of the posterior observation residual vector can be determined (e.g., estimated, calculated, etc.) from the posterior observation residual covariance:

$${σ}^{2} = \frac{{v}^{T} {R}_{k}^{- 1} v}{D O F}$$

where DOF is degrees of freedom and where v can alternatively be written as Sz where S is an matrix having a trace equivalent to the DOF. From this, it can be said that S=I−HₖP_{k|k}Hₖ^{T}Rₖ⁻¹. This variance can be used to scale the residuals \tilde{v}_{k|k} (e.g., by dividing residuals by their associated standard deviations or by their associated variances). The scaled residuals are then compared to a threshold window (e.g., one corresponding to plus or minus 3 standard deviations from the mean), and any observations falling outside the threshold window can be flagged as (probable such as with greater than a threshold probability of being) outlier observations. The threshold is preferably on the order of about 10 cm (e.g., 5-20 cm). Smaller thresholds can be more selective (e.g., more accurate positioning solution), but provide less availability and the opposite can be true for larger thresholds (e.g., less accurate positioning solution but greater availability). However any suitable threshold(s) can be used (e.g., less than 10 cm, greater than 10 cm, depending on accuracy needs of an application, depending on availability needs of an application, etc.).

In a second specific example, a GNSS estimator can detect GNSS outliers by: generating a set of posterior observation residual covariances from the set of posterior observation residual values; calculating a set of posterior observation residual variances from the set of posterior observation residual covariances; identifying a presence of statistical outliers in the set of satellite positioning observations based on a first number of the set of posterior observation residual variances being outside a threshold range; generating a first reduced set of satellite positioning observations by removing a first subset of the set of satellite positioning observations; recalculating the set of posterior observation residual variances using the first reduced set of satellite positioning observations; determining that a number of the set of recalculated posterior observation residuals outside the threshold range is lower than the first number; and in response to this determination, identifying a subset of the GNSS observations as statistical outliers.

In a variation of the second specific example (sometimes referred to as a variance threshold technique), the posterior residual, posterior residual covariance, and posterior residual variance can be calculated as in the first specific example (and/or variations thereof). This variation can be particularly (but not exclusively) useful for differenced measurements (and as such can be implemented with or benefit from using displacements in addition to or alternative to positioning solutions) as differenced measurements can be correlated, and thus more likely to result in an outlier in one observation corrupting residuals that correspond to different observations.

In this variation, the posterior residual variances can be examined (e.g., compared to a threshold) directly. If one or more posterior residual variances is outside of a threshold range (e.g., one corresponding to plus or minus 1, 2, 3, 5, etc. standard deviations from the mean), this can be an indication that one or more outliers may be present in the observation data. The threshold is preferably on the order of about 10 cm (e.g., 5-20 cm). However any suitable threshold(s) can be used (e.g., less than 10 cm, greater than 10 cm, depending on accuracy needs of an application, depending on availability needs of an application, etc.).

In this variation of the second example, detecting one or more outliers can include removing a set of observations and recalculating the posterior residual variances. When the posterior residual variances fall below threshold levels, the algorithm can stop here. However, additionally or alternatively, the algorithm can try removing a different set of observations (and so on, until at least one or more of them falls below threshold levels, to find the highest quality posterior residual variances, etc.). Alternatively stated, the algorithm can continue until the number of posterior residual variances outside of a threshold range is less than a threshold number.

Alternatively, in this variation, detecting one or more outliers can include calculating posterior residual variances for a number of set-reduced observations (i.e., different subsets of the whole set of observations) and choosing the reduced set with the lowest variance.

In a third specific example, a GNSS estimator can detect GNSS outliers using a combination of the first and second specific example of detecting GNSS outliers. In a variation of the third specific example, detecting outliers in a manner similar to the second specific example of outlier detection when a number of posterior residual variances outside of a threshold range is greater than (or equal to) a threshold number and detecting outliers in a manner similar to the first specific example when the number of posterior residual variances outside of a threshold range is less than or equal to the threshold number. In a second variation of the third specific example, detecting outliers can be performed in a manner similar to the first specific example of outlier detection when a number of posterior residual variances outside of a threshold range is greater than (or equal to) a threshold number and detecting outliers can be performed in a manner similar to the second specific example when the number of posterior residual variances outside of a threshold range is less than or equal to the threshold number.

In a variation of the third specific example (sometimes referred to as a hybrid technique), the posterior residual, posterior residual covariance, and posterior residual variance can be determined (e.g., estimated, calculated, etc.) as in the scaled residual technique. The posterior residual variances can be examined. When one or more posterior residual variances is above a threshold (e.g., the same or a different threshold than the one mentioned in the variance threshold technique), outlier(s) can be detected using a variance threshold technique. When one or more posterior residual variances is less than or equal to the threshold, the outlier(s) can be this variation can select between the variance threshold and scaled residual techniques in any manner (e.g., based on the number of above-threshold or below-threshold posterior residual variances, a magnitude of the posterior residual variances, a posterior residual covariance threshold, a posterior residual magnitude, etc.). The threshold is preferably on the order of about 10 cm (e.g., 5-20 cm). However any suitable threshold(s) can be used (e.g., less than 10 cm, greater than 10 cm, depending on accuracy needs of an application, depending on availability needs of an application, etc.).

In a fourth specific example, outliers can be detected using a scaled residual technique, a variance threshold technique, a hybrid technique, and/or any suitable technique or combination of techniques such as those disclosed in U.S. patent application Ser. No. 16/748,517 titled ‘SYSTEMS AND METHODS FOR REDUCED-OUTLIER SATELLITE POSITIONING’ filed 21 Jan. 2020 incorporated in its entirety by this reference.

However, outliers can be detected based on a measurement innovation and/or can otherwise be detected.

Mitigating an effect of the outlier(s) S400 functions to reduce or remove an impact of outliers (e.g., detected outliers) on an updated receiver positioning solution (e.g., as calculated in S500, future estimated receiver positioning solutions, etc.). S400 can be performed by an outlier mitigator, a computing system, a receiver, and/or by any suitable component. All outliers (e.g., outliers detected in S300) can be mitigated, a subset of outliers can be mitigated (e.g., a most egregious outlier can be mitigated and then satellite observations can be reevaluated for whether they are outliers, outliers beyond a mitigation threshold can be mitigated, etc.), and/or any suitable outliers can be mitigated. Outlier(s) are preferably detected in the GNSS observations, but can additionally or alternatively be detected in the sensor data and/or in any suitable dataset(s).

Mitigating the effect of outliers can include: removing one or more GNSS observations from the set of GNSS observations, applying a weight factor to one or more GNSS observations (e.g., apply a smaller weight factor to outliers, apply a larger weight factor to inliers, etc.), acquiring additional GNSS observations, repairing (e.g., correcting) a cycle slip (e.g., when S300 identifies, verifies, etc. outlier(s) as probable cycle slip(s)), adding new observations (e.g., synthetic satellite observations) with negative variances as updates to the positioning solution estimate (the new observations serving to remove the effects of detected outlier observations), and/or any suitable mitigation steps.

Mitigating the effect of outliers can be performed once, a predetermined number of times, until a criterion is met, iteratively with S300 (e.g., detecting whether any outliers are present in the dataset and mitigating the outliers before repeating an outlier detection to see if the mitigation removes the outliers), and/or with any suitable frequency, period, and/or repetition rate. S400 and S300 are preferably performed iteratively until all outliers have been mitigated (e.g., removed from the dataset, weighted such that the previously identified outliers are no longer detected as outliers, as shown for example in FIG. 4, etc.). However, S300 and S400 can be performed iteratively until: the dataset includes GNSS observations from at most a threshold number of satellites (e.g., GNSS observations only associated with 1, 2, 3, 4, 5, 10, etc. unique satellites), a threshold fraction of satellite observations are outliers, the dataset includes GNSS observations from at most a threshold number of satellite constellations, a subset of outliers have been mitigated (e.g., outliers with a greatest difference relative from inliers, outliers with a large impact on the receiver positioning solution, outliers with a large covariance, etc.), for a target number of iterations, until a threshold residual is achieved, until a change in a positioning solution changes by at most a threshold amount, and/or until any suitable iteration criteria is achieved.

The GNSS estimator (e.g., outlier detector associated therewith, outlier mitigator associated therewith, memory, cache, etc.) used to detect the outliers (e.g., the secondary GNSS estimator, duplicate GNSS estimator, etc.) preferably retains (e.g., stores) the GNSS observations that are identified as outliers along with any mitigation process(es) applied thereto. However, the GNSS estimator can additionally or alternatively transmit the outliers (and/or mitigation effects) to the primary GNSS estimator (e.g., as outliers are detected) and/or fusion estimator, and/or can otherwise provide information regarding outliers to other endpoints. After outliers are detected (e.g., iterations are complete), the outliers (and/or associated mitigation processes) can be transmitted to the primary GNSS estimator. However, additionally or alternatively, one or more states of the second GNSS estimator can be transmitted (e.g., to avoid updating the primary GNSS estimator, for instance a second GNSS receiver positioning solution can be transmitted), and/or any suitable data or information can be transmitted to the GNSS estimator, fusion estimator, and/or other suitable endpoint(s).

Determining the updated receiver positioning solution S500 functions to determine the GNSS receiver position using outlier mitigated data. S500 can be performed in the same and/or a different manner from S200. The updated receiver positioning solution can have a higher availability, greater accuracy, better integrity, and/or otherwise be related to the receiver positioning solution (e.g., from S200). As an illustrative example, a filter (e.g., a positioning engine filter, GNSS estimator, fusion engine, etc.) can be updated to remove or update states associated with satellite observations that were identified as outliers. S500 is preferably performed when at most a threshold fraction (e.g., percentage) of the total satellite observations are identified as outliers (e.g., probable outliers). In a specific example, the threshold percentage can be about 50% (i.e., when 50% or fewer of the total satellite observations are identified as outliers, S500 can be performed). However, the threshold percentage can additionally or alternatively be 10%, 20%, 25%, 30%, 33%, 40%, 60%, 70%, 75%, 80%, 90%, 95%, and/or any suitable value or range therebetween. However, S500 can be performed when any fraction of the satellite observations has been identified as outliers. Another technical advantage conferred by S300 and/or S400 on the performance of S500 in some variants is that the set out outlier mitigated satellite observations can include satellite observations associated with fewer than 4 satellites (e.g., because the data quality of those satellite observations can be assured with sufficient accuracy). The use of satellite observations associated with fewer than 4 satellites can be beneficial for improving an availability of a satellite positioning solution in a noisy environment (e.g., in a dense urban environment). However, satellite observations associated with greater than 4 satellites can be used.

In variants, the receiver positioning solution (e.g., the original receiver positioning solution, the updated receiver positioning solution, an intermediate receiver positioning solution, etc.) can be transmitted to an external system, stored (e.g., cached), used to operate and/or control an external system, used to generate operation instructions for an external system (e.g., using a GNSS receiver computing system, an external system computing system, etc.), and/or used in any manner.

The methods of the preferred embodiment and variations thereof can be embodied and/or implemented at least in part as a machine configured to receive a computer-readable medium storing computer-readable instructions. The instructions are preferably executed by computer-executable components integrated with a system for GNSS PVT generation. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A system comprising:
a GNSS receiver configured to measure satellite observations associated with one or more satellites;
a sensor, collocated with the GNSS receiver, configured to measure sensor measurements;
a positioning engine configured to determine a positioning solution of a body by processing the satellite observations with a positioning filter;
a fusion engine configured to determine a fused positioning solution of the body using the sensor measurements and the positioning solution; and
an outlier detector configured to:
generate a duplicate positioning filter configured to receive the positioning solution and the fused positioning solution; and
detect outliers in the satellite observations using the duplicated positioning filter;
wherein when outliers are detected, detected outliers are provided to the positioning engine and the positioning engine updates the positioning solution based on the detected outliers.
